(19) United States
(12) Patent Application Publication
(10) Pub. No.: US 2012/0063139 A1
(43) Pub. Date: Mar. 15, 2012

(54) Light Band and Method for Producing a Light Band

(76) Inventors: Ulrich Benkart, Aindling-Binnenback (DE); Andreas Kampfrath, Niederstrotzingen (DE); Anton Lauerer, Riedenburg (DE)

(21) Appl. No.: 13/320,527

(22) PCT Filed: May 11, 2010
(86) PCT No.: PCT/EP2010/056459

§ 371 Date: Nov. 14, 2011

(30) Foreign Application Priority Data
May 12, 2009 (DE) 102009020851.8

(51) Int. Cl. F21V 21/00; B23P 11/00

(52) U.S. Cl. 362/249.02; 29/428

(57) ABSTRACT

A light band (1;19;33;40), comprising a band-shaped carrier (4,5) for at least one light source (6), in particular a light emitting diode (6), wherein the carrier includes electrical contacts (7), and at least one sealing hood (2,2a,2b;10,10a,10b;16;34; 41a,41b) fastened to the carrier (4,5), which at least partially overarches at least one of the electrical contacts.

The invention relates to a light band, in particular an IP protected LED band, and a method for producing a light band.

Flexible bands (LED Flex bands) equipped with light emitting diodes are known which can be divided into LED modules without loss of functionality and are equipped with a self-adhesive backing. Thus, the LINEARlight Flex range from the Osram Company is known, for example, in which an LED band is available wound on a roll (the LM1X range for example), whereby the LED band comprises 120 to 600 LEDs, depending on the design. The basic size of the LED band (L×W×H) is 8400 mm×10 mm×3 mm. The basic size of an LED module having ten LEDs (L×W) is 140 mm×10 mm. The LED bands or the LED modules can be connected mechanically and electrically to one another and also to a power supply by means of proprietary connectors, for example from the CONNECTSystem range from the Osram GmbH company.

In addition, LED bands are known which in order to establish an IP protection are inserted into a U profile which is band-shaped in the longitudinal direction and are then completely encapsulated using a transparent encapsulation compound. On account of the continuous surface formed by the encapsulation compound, an LED band thus encapsulated can prevent cracks, which could result in a penetration of dirt or moisture, from occurring between the light emitting diodes and the encapsulation compound when the lighting module is bent.

The object of the present invention is to provide a means for making contact with a field configurable light band which is particularly simple to manufacture and gives a reliable seal.

This object is achieved in accordance with the features of the independent claims. Preferred embodiments are set down in particular in the dependent claims.

The light band has a band-shaped carrier for at least one light source, whereby the carrier is equipped with electrical contacts. The light band furthermore has at least one sealing hood which is fastened to the carrier, whereby the sealing hood at least partially overarches at least one of the electrical contacts.

As a result of fastening the sealing hood, a receiving space is formed for the introduction of a plug connector because the sealing hood overarches the electrical contacts according to type in a spaced manner or with a spacing. The electrical contacts are exposed towards the receiving space. The plug connector can thus make contact with the at least one electrical contact after being introduced into the receiving space.

The sealing hood seals the receiving space off from the remaining region of the light band, which means that in order to maintain a protection, in particular IP protection, of the light band only the receiving space itself intrinsically needs to be sealed off. This is possible in a particularly simple manner because the sealing hood makes available a well defined receiving space into which the plug connector can be inserted without further adaptation effort and with a reliable fit; by this means, a tight plug assembly can also be effected by a technically untrained end customer without any loss of an IP classification. An already available plug connector can be used as a plug connector. The sealing hood can be manufactured inexpensively and can moreover be simply and reliably attached to the carrier.

The carrier can be a flexible or bendable carrier, a partially flexible carrier or a rigid carrier. Due to the fact that the sealing hood can be designed comparatively compactly, even a flexible carrier does not suffer any significant loss to its bending capacity.

The type of the light source is not restricted. In one embodiment, the at least one light source can comprise a compact fluorescent lamp. In another embodiment, the at least one light source can comprise a semiconductor light source such as a light emitting diode and/or a diode laser.

The light source can for example comprise one light emitting diode or a plurality of light emitting diodes. The individual light emitting diodes can in each case emit a single color or multiple colors, for example white. If a plurality of light emitting diodes is present per light source, these can for example emit in the same color (single color or multiple colors) and/or different colors. A plurality of individual LEDs together can therefore yield a white mixed light, for example in ‘cold white’ or ‘warm white’. In order to produce a white mixed light, light emitting diodes which emit in the primary colors red (R), green (G) and blue (B) can for example be brought together. In this situation, individual or multiple colors can also be produced simultaneously by a plurality of LEDs; combinations RGB, RRGB, RGGB, RGBB, RGGBB etc. are therefore possible. The color combination is not however restricted to R, G and B (and A). In order to produce a warm white color shade, one or more ‘amber’ (A) LEDs can for example also be present. With regard to LEDs having different colors, these can also be controlled such that they emit in a tunable RGB color range. In order to produce a white light from a mixture of blue light and yellow light, blue LED chips provided with fluorescent material can also be used, for example using surface mount technology, for example ThinGaN technology. A simple scalability of the luminous flux can be achieved by using a plurality of white single chips. The single chips and/or the LED groups can be equipped with suitable optical systems for beam guidance, for example Fresnel lenses, collimators, and so forth. Instead of or in addition to inorganic light emitting diodes, for example based on InGaN or AlInGaP, organic LEDs (OLEDs) can generally also be employed.

In a further embodiment, at least some of the electrical contacts can be arranged in the region of at least one of the two end faces (on the end face) of the carrier, which in particular facilitates a plug connection with the light band. To enable contact to be made on both sides, electrical contacts are advantageously arranged in the region of both end faces.

In one development, the sealing hood has at least one internal sealing element. An internal sealing element can in particular be understood to be a sealing element (arranged on an inner surface of the sealing hood) directed into the receiving space. By this means, the receiving space can be sealed even more reliably against foreign bodies (dust etc.) and/or moisture, and this can also be done without a specially adapted plug connector.

Alternatively or in addition, the at least one sealing element can be arranged on an outer surface of the sealing hood, for example in the case of a plug connector to be fitted over the sealing hood.

The at least one sealing element can be arranged continuously on the sealing hood with respect to a circumferential direction in order to even more effectively prevent any penetration of foreign particles and moisture.

In one embodiment, the at least one sealing element has at least one sealing lip. This can be designed simply with or on the sealing hood.

A plurality of sealing elements, in particular sealing lips, can be arranged one behind the other in order to increase the sealing effect.

In a further development, the sealing hood has a housing having an open underside, whereby the underside is closed by the carrier. The sealing hood and the carrier then delimit or form the receiving space. The sealing hood can in particular have an (inverted) U-shaped profile cross-section. The U-shaped profile cross-section can be straight or bent in the region of its free edges. The sealing hood can preferably simply be fitted onto the carrier, or vice versa, in order to form the receiving space.

The sealing hood can be fitted onto an upper side (which for example can carry the at least one light source) and/or an underside (which for example can be provided for fastening the carrier) of the carrier, or the carrier can be inserted into the open underside of the sealing hood such that the sealing hood and the carrier are connected to one another by way of a side surface of the carrier.

In another embodiment, the sealing hood forms a housing closed at least on the shell side (with respect to a longitudinal extension of the light band), which has at least one lead-through for at least one of the electrical contacts. With regard to the housing closed on the shell side, the housing is fitted onto the carrier by means of that shell-side wall in which the lead-throughs are also situated. On account of the large contact area with the carrier, this embodiment can be fastened particularly simply and firmly to the carrier. By means of the lead-throughs it is moreover possible to achieve a simple alignment of the sealing hood. In the non-divided state this sealing hood can be completely closed except for the lead-throughs.

In a further embodiment, the at least one sealing hood has at least one electrically conductive socket for receiving a contact pin and the at least one socket is electrically connected in each case to one of the electrical contacts, in particular is seated thereon. By this means it is also possible to create a connection facility for a plug connection which has at least one connector pin.

In another embodiment, the at least one socket is molded in a housing. This results in a stable and well protected connection facility.

In a further embodiment, the at least one socket is soldered to the respective electrical contact. A reliable electrical connection is thus ensured.

In yet another embodiment, the at least one sealing hood is arranged on one end face of the light band and is open towards the end face. By this means a plug connector can be pushed into the receiving space without further preparations.

In a further embodiment, the at least one sealing hood is arranged in sealing fashion on an internal section of the carrier and overarches at least one dividing point of the light band. This sealing hood is thus not arranged on the end face of the carrier but at a distance therefrom on a section internal with respect to the longitudinal extension of the carrier. The sealing hood can have at least one dividing point, the position of which essentially matches a position of the dividing point of the light band.

The light band can be separated at the dividing point and is consequently field configurable. A light band can have one or more dividing points which are advantageously overarched in each case by a sealing hood. In this embodiment, the sealing hood seals the region of the carrier covered by it and in particular the electrical contacts against dust and/or moisture. Should the light band not be separated at this dividing point, the sealing hood can permanently offer an adequate level of protection, for example in order to maintain an intended IP protection class.

In order that the light band also still remains simple to field configure with the at least one sealing hood, the respective sealing hood advantageously likewise has at least one dividing point at a position essentially corresponding to the dividing point of the carrier in particular in relation to the longitudinal extension of the light band. This means that the sealing hood and the carrier can be divided in a common division operation. The dividing point can be identified by a marking and/or be designed physically as a dividing point, for example through the provision of one or more notches etc.

Alternatively, the sealing hood can also manage without a firm or distinct dividing point or marking thereof. This can be advantageous for example if a user is able to recognize a positioning of the dividing point of the carrier even without a dividing point on the sealing hood, for example if the sealing hood allows a view of the carrier and thus of its dividing point or if the carrier has a marking outside the region overarched by the sealing hood, for example on a side facing away from the sealing hood or to the side of the sealing hood.

The light band can both have sealing hoods which are divided or already open on the end face, namely on end faces of the light band, and also have internal sealing hoods which are not divided. By dividing the light band at a dividing point, two separate light bands are produced, each of which now has at the dividing point a sealing hood fastened to the carrier and open on the end face, whereby the respective sealing hood overarches at least one electrical contact at least partially.

To this end, on both sides of the dividing point of the undivided light band electrical contacts can typically be prepared which in the undivided state are electrically connected to one another electrically at least partially beyond the dividing point and are electrically separated by the division and then serve as contacts arranged on the end face.

In a further embodiment, the light band has a plurality of integrally contiguous, essentially identical unit carrier sections (“lighting modules”), whereby two adjacent lighting modules can be divided at a common dividing point.

The sealing hood can in particular be manufactured from a dividable, in particular cuttable material. This means that it can be produced comparatively inexpensively in a uniform manufacturing process. The cuttable material can in particular be a soft elastic material. The soft elastic material can for example comprise a soft elastic plastic, silicone or rubber. To enable even an end user to perform a simple division the sealing hood and the light band can be cuttable, for example by using a knife and/or scissors.

In an alternative embodiment, the sealing hood has housing walls comprising a comparatively hard material and the dividing point comprises a comparatively soft material. The hard material can for example comprise a comparatively hard plastic such as PA, PU, PET or POM, a hard rubber, hard silicone etc., whereas the dividing point comprises for example a softer material such as soft-formed silicone or rubber. The materials are not however restricted to the stated materials; rather, all materials suitable for the predetermined sealing function can be used, such as other plastics or non-plastics. With regard to an unseparated sealing hood, the dividing point can also serve as an expansion joint for example to compensate for manufacturing tolerances. The sealing hood can be constructed as a composite component from the comparatively hard material and the comparatively soft material.

According to a development, the sealing hood can be coated at least partially with a protective coating in order for example to satisfy the prerequisites for one or more IP protection classes. The protective coating can comprise at least one protective lacquer or at least one encapsulation compound.

According to a further development, the sealing hood can in this situation be at least partially lacquered or encapsulated at the same time, which results in a stronger fastening on the carrier and moreover avoids gaps between the sealing hood and the protective coating, through which moisture and/or foreign particles can penetrate.

The wall thickness of the sealing hood can advantageously be between approx. 0.3 mm and 0.4 mm in order to be able to make available a sufficiently large joining surface even in the case of fitting onto the edge of the carrier, in particular if the joint is effected by means of an adhesive.

The object is also achieved by a method for producing a light band, wherein (i) the at least one sealing hood is fitted onto the carrier and subsequently (ii) the light band is at least partially encapsulated.

The light band can for example be encapsulated at least on a side holding the light sources at least between the sealing hoods. To facilitate encapsulation the carrier can be inserted in an open-topped encapsulation profile, for example a U profile or a C profile.

In one embodiment, a housing of the sealing hood is adhesively bonded to the carrier prior to encapsulation. This means that a tight seating of the sealing hood on the carrier during the encapsulation process is ensured.

In a further embodiment, the at least one socket is soldered to the respective electrical contact prior to encapsulation. This means that reliable contact with the sockets on the carrier is ensured.

The invention will be described schematically in greater detail in the following figures with reference to exemplary embodiments. In this situation, the same elements or elements having the same function can be identified by the same reference characters for the sake of clarity.

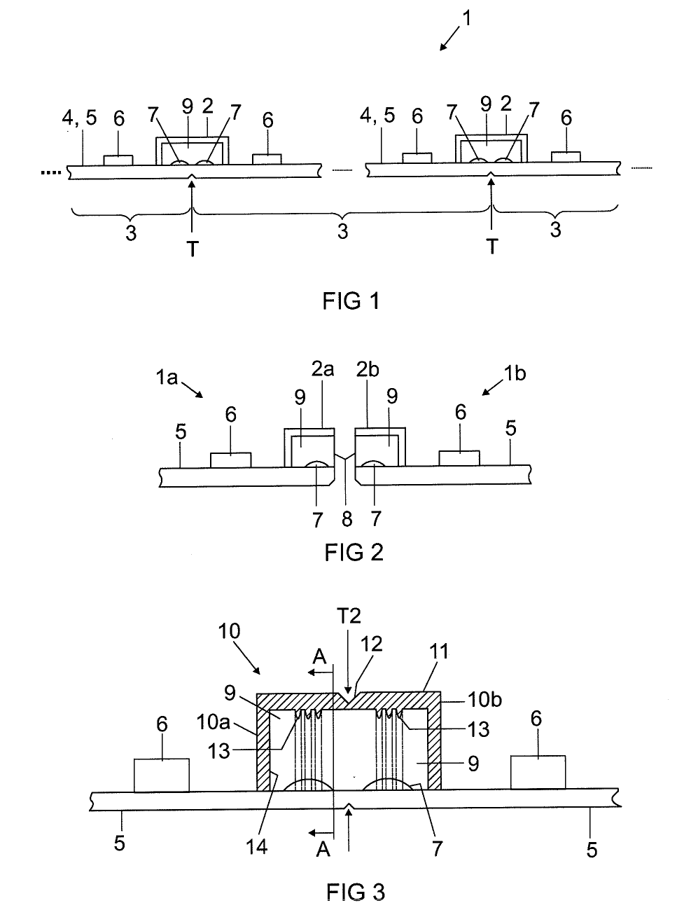

FIG. 1 shows a side view in a sectional representation of a light band having a plurality of undivided sealing hoods;

FIG. 2 shows the light band from FIG. 1 in a region of a divided sealing hood;

FIG. 3 shows a more detailed side view in a sectional representation of a sealing hood according to a first embodiment;

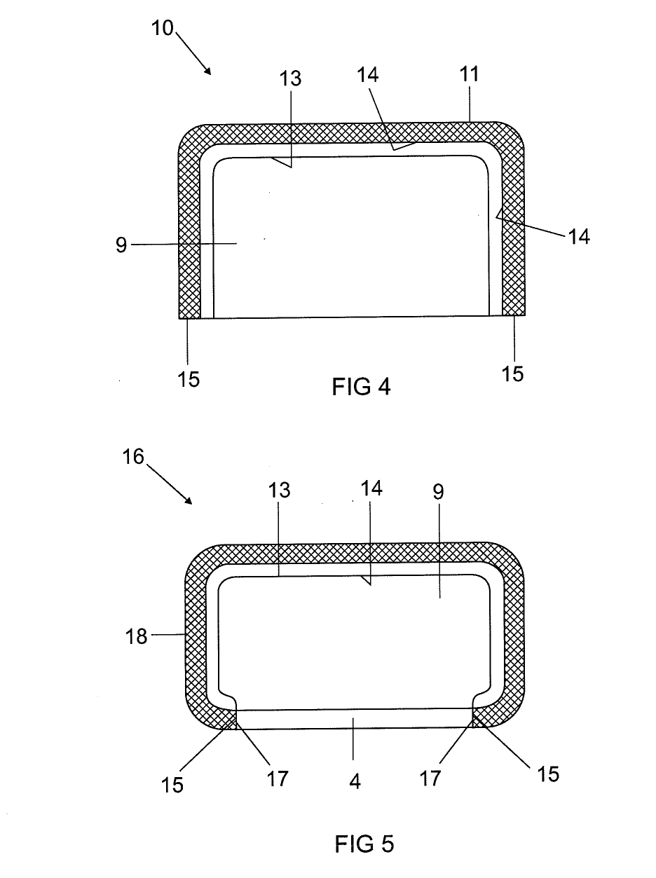

FIG. 4 shows a front view of a sectional plane A-A from FIG. 3 of the sealing hood according to the first embodiment;

FIG. 5 shows a view similar to FIG. 4 of a sealing hood according to a second embodiment;

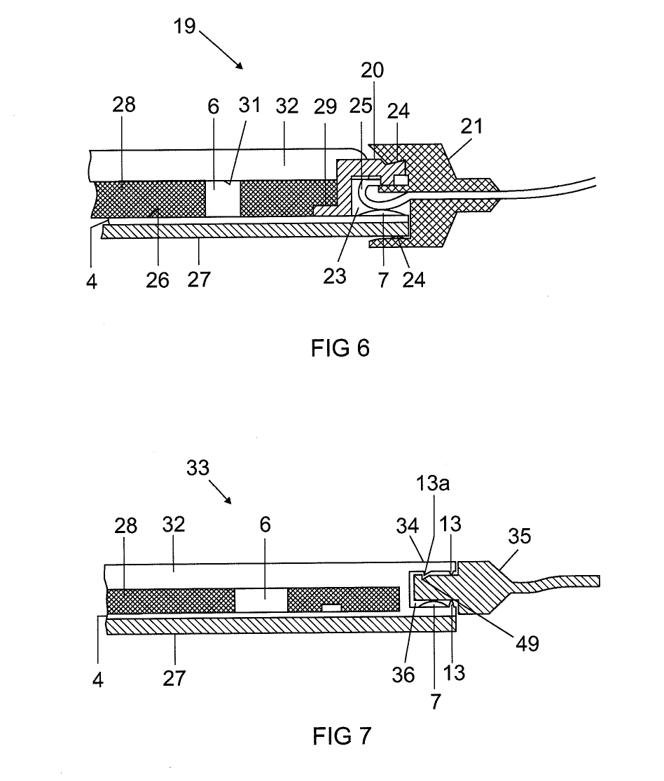

FIG. 6 shows a side view in a sectional representation of a light band having a divided sealing hood according to a third embodiment;

FIG. 7 shows a side view in a sectional representation of a light band having a separated sealing hood according to a fourth embodiment;

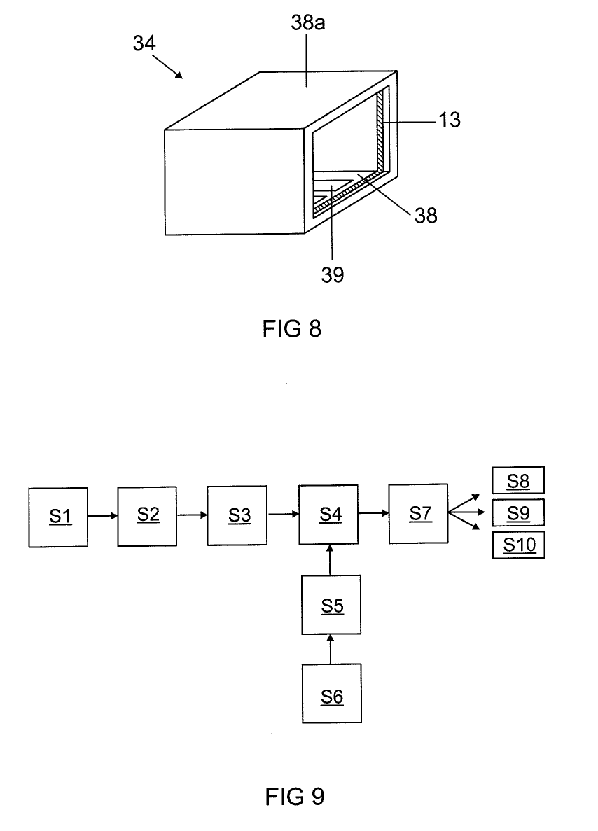

FIG. 8 shows an oblique view of the sealing hood from FIG. 7;

FIG. 9 shows a process sequence for equipping a carrier with a sealing hood;

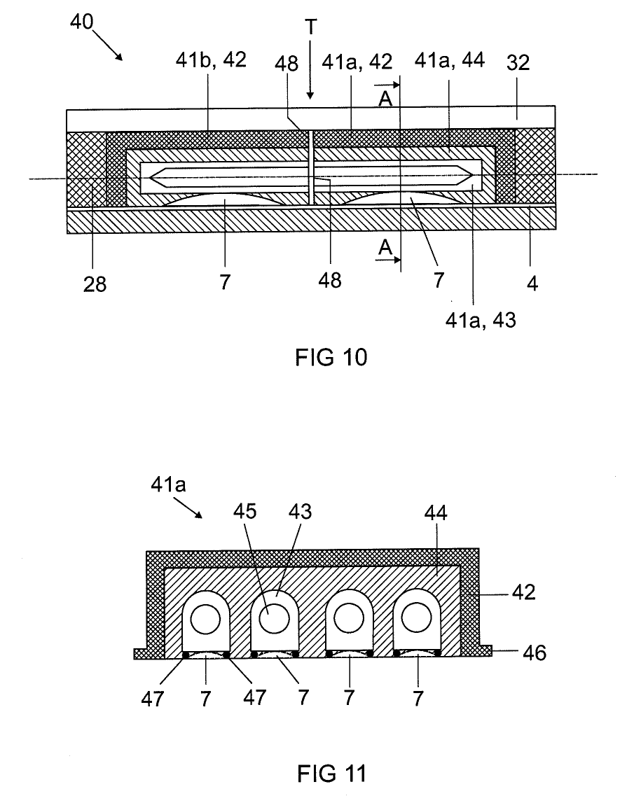

FIG. 10 shows a side view in a sectional representation of a light band having a sealing hood according to a fourth embodiment.

FIG. 11 shows a front view of the sealing hood according to the fourth embodiment.

FIG. 1 shows a side view in a sectional representation of a light band 1 having two sealing hoods 2. The light band 1 is composed of a plurality of identically constructed lighting modules 3. Each of the lighting modules 3 has a band-shaped, flexible module carrier 5 which is equipped on its upper side with a plurality of light emitting diodes 6. The module carriers 5 of adjacent lighting modules 3 are integrally connected to one another and can be divided at a dividing point T. On both sides of the dividing point T are arranged electrical contacts 7 in the form of solder pads which in the undivided state shown here are connected to one another in electrically conductive manner beyond the dividing point T and after a division at the dividing point T are electrically separated and then serve as contacts of the respective lighting module 3 arranged on the end face. The individual contiguous module carriers 5 together form a carrier 4 of the light band 1.

The sealing hoods 2 are fitted on the band-shaped, flexible carrier 4 such that in each case they overarch two adjacent module carriers 5 in sealing fashion at their dividing point T together with the contacts 7 prepared there. By this means, the overarched region of the carrier 4 can be protected against foreign bodies such as dust etc. and/or against moisture. The respective sealing hood 2 and the carrier 4 form a closed receiving space 9 which is prepared for receiving a plug connector.

The carrier 4 or its module carriers 5 can subsequently be provided with a protective coating at least in a region between the sealing hoods 2, in particular in order to protect the light emitting diodes 6. The protective coating can for example be a coat of lacquer or an encapsulation. By means of the protective coating, it is for example possible to achieve a particular IP protection class. The protective coating can also at least partially cover the sealing hoods 2.

The carrier 4 can be separated between the two module carriers 5 at the dividing point T. To this end, the associated sealing hood 2 must also be separated. In order to enable an easy separation, the sealing hood 2 here consists of a soft elastic material. A cutting method using scissors for example can be advantageous as a simple division method for achieving a defined and clean division surface.

After the light band 1 has been divided at the dividing point T, two new, separate and consequently shorter light bands 1a, 1b have been created, as shown in FIG. 2. The correspondingly divided sealing hoods 2a, 2b of the associated light bands 1a, 1b are now in each case arranged on the end face with respect to the respective light band 1a or 1b and are open towards their end face 8 (which corresponds to the end face of the light band 1). The divided sealing hood 2a or 2b with the respective module carrier 5 in each case forms the receiving space 9 open on the end face for receiving the plug connector. The plug connector, for example a plug, can be introduced through the open end face 8 into the receiving space 9 serving as a socket.

FIG. 3 shows a more detailed side view in a sectional representation of an undivided sealing hood 10 according to a first embodiment. The sealing hood 10 can for example be used as the sealing hood 2 from FIG. 1 and FIG. 2. The housing 11 of the sealing hood 10 is formed from a soft elastic material, for example from silicone or rubber, which can be divided for example by using a knife or scissors. To enable a user to simply recognize a dividing point T of the carrier 4, a dividing point T2 is also marked on the sealing hood 10 by means of an indentation 12.

Three rows of elastic sealing lips 13 are arranged in each case in each of the then corresponding sealing hoods 10a, 10b divided through a division of the sealing hood 10 at the dividing points T, T2. The sealing lips 13 run continuously on an inner surface 14 of the sealing hood 10, in other words such that the sealing lips 13 project into the receiving space 9. By means of the sealing lips 13, a possible gap between a plug connector and the sealing hood 10 or 10a, 10b can be closed up in order to seal off the respective receiving space 9.

FIG. 4 shows a front view of a sectional plane A-A from FIG. 3 of the sealing hood 10 according to the first embodiment. The housing 11 has an inverted U shape with rounded corners. The housing 11 is designed such that its lower free edges 15 rest on the carrier 4 as joining surfaces and are adhesively bonded there. A wall thickness of the housing 11 and thus a width of the edges 15 is between approx. 0.3 mm and 0.4 mm in order to attain a sufficiently high adhesive strength. The sealing lips 13 run continuously on the inner surface 14 of the housing 11 in a circumferential direction with respect to the longitudinal direction of the carrier 4.

FIG. 5 shows a view similar to FIG. 4 of a sealing hood 16 according to a second embodiment. In contrast to the first embodiment the lower, free edges 15 of the sealing hood 16 are now bent over horizontally inwards. The sealing hood 16 can be fastened by these edges 15 as the joining surfaces to side surfaces 17 of the carrier 4. The sealing lips 13 are here also arranged continuously on the inner surface 14 of the housing 18 in a circumferential direction.

FIG. 6 shows a side view in a sectional representation of a light band 19 having a divided (separated) sealing hood 20 arranged on the end face according to a third embodiment. The carrier 4 is encapsulated, twice in fact, on its upper side 26 carrying the LEDs 6. A first, opaque encapsulation compound 28 consisting of flexible silicone has been molded on the carrier 4 such that an upper emission surface 31 of LEDs 6 is not covered thereby. The first encapsulation compound 28 prevents a view of the surface of the carrier 4 with the LEDs 6 (except for their emission surfaces 31), conductor paths and where applicable electronic elements applied thereon. Onto the first, opaque encapsulation compound 28 has been applied a second, essentially transparent encapsulation compound 32 consisting of flexible silicone which does not significantly absorb the light emitted upwards by the LEDs 6 at the emission surface 31. These two encapsulation compounds 28, 32 protect the carrier 4 with the components applied thereon for example in order to meet the requirements of a particular IP protection class and maintain flexibility of the light band 19.

For simple encapsulation purposes the light band 19 has been inserted into a U-shaped profile rail 27, the underside of which is visible here. The profile rail 27 likewise consists of silicone in order to maintain flexibility of the light band 19.

A plug 21 has been pushed onto an end-face region of the light band 19 from the outside, namely both over the sealing hood 20 and also over the part of the carrier 4 overarched by the sealing hood 20. In order to seal the receiving space 23, the plug 21 now has sealing lips 24 running in the circumferential direction. At least one clamp wire 25 is introduced into the receiving space 23 in order to make contact with a respective electrical contact 7. The clamp wire 25 also serves to secure the plug 21 against accidental removal. To this end, the clamp wire 25 interlocks with a sealing lip 24 in the sealing hood 20.

The sealing hood 20 has a projection 29 directed backwards which serves to increase the contact area with the carrier 4 or the module carrier 5 and thus provide a better fastening.

The sealing hood 20 is partially included in the encapsulation. The projection 29 in particular also serves to achieve a better joint with the first encapsulation compound 28, by which it is completely covered. By means of the partial encapsulation also of the sealing hood 20 it is possible to prevent the formation of a gap between the sealing hood 20 and the encapsulation compounds 28, 32 and to achieve a better seating of the sealing hood 20 on the carrier 4.

FIG. 7 shows a side view in a sectional representation of a light band 33 having a separated sealing hood 34 according to a fourth embodiment.

In contrast to the third embodiment, a plug 35 for making electrical contact with the light band 33 is inserted into the receiving space 36, namely through an end-face opening in the sealing hood 34. The plug 35 makes contact on one side, here: its underside, with the electrical contacts 7 and butts in the circumferential direction against an internal sealing lip 13 of the sealing hood 34. The sealing hood 34 is not included in the encapsulation, but only the part of the carrier 4 situated between the sealing hoods 34. Here too, security is provided against accidental removal. For this purpose a sealing lip 13a situated on the sealing hood 34 interlocks with a notch 49 in the plug 35.

FIG. 8 shows an oblique view of the divided sealing hood 34 from FIG. 7. The sealing hood 34 is (with respect to a longitudinal extension of the light band 33) closed on the shell side and to the rear and therefore open only on the end face. On the lower shell side 38 of the housing 38a the sealing hood 34 has lead-throughs 39 for feeding the electrical contacts 7 through. The lead-throughs 39 are also suitable for positioning the sealing hood 34 on the carrier 4. The sealing hood is consequently closed on all sides in the undivided state except for the lead-throughs 39. The sealing lips 13 are designed running completely circumferentially in the circumferential direction.

FIG. 9 shows a possible process sequence for equipping a carrier with a sealing hood (hood assembly).

In a step S1, a quasi endless panel is unwound. A panel here can be understood in particular to be a larger endless carrier composed of a plurality of equipped or unequipped flexible, band-shaped quasi endless carriers (quasi endless flexbands) for improved handling, for example a panel composed of six quasi endless carriers arranged parallel to one another. The carrier in turn can be composed of a plurality of module carriers connected integrally one after the other. Advantageously, the carriers can already be equipped with the light sources and where applicable with electronic components, in other words be present as light bands.

In a following step S2, a surface of the panel or of the carriers provided for assembly of the sealing hoods is surface treated at least in certain areas, for example plasma treated, in order to roughen the surface of the panel or of the carriers.

This means that in a following step S3 an adhesive medium, in particular an adhesive, can be applied to the surface with good adhesion. The adhesive medium can for example be stamped onto the carrier or can be applied during the course of a blade coating process.

These three steps S1 to S3 serve to prepare the carrier for marrying up with the sealing hoods.

In a step S4, the sealing hoods are fed. The sealing hoods can be fed for example in a tray, a blister belt or a tube.

In a subsequent step S5, the sealing hoods are dipped into an adhesive medium, which may be the same as the adhesive medium from step S3 but need not be. The adhesive media from step S3 and step S5 can therefore be two different components of a two-component adhesive. As an alternative to dipping the sealing hood, this can also be stamped or blade coated with the adhesive medium.

These two steps S4 and S5 serve to prepare the sealing hoods for marrying up with the carrier or carriers.

Step S6 serves to marry up sealing hood(s) and carrier(s), for example within a “pick-'n'-place” assembly process.

In the following step S7, the adhesive is cured, for example by means of a heat curing or UV curing process. This concludes the fitting of the sealing hoods.

In a following step S8, the equipped panel can be wound up again and for example transported onwards for further processing or stored.

In a step S9, an alternative to step S8, the panel or the carriers is/are lacquered with a protective lacquer. The protective lacquer can for example be a thick film. A possible material for a protective lacquer is the UV-curing thick film lacquer Twin-Cure DSL 1600 EFLZ from the Lackwerke Peters company.

More precisely, step S9 can be performed such that adequate adhesion of the sealing hoods is first checked. The functioning of the light sources can also be checked within the framework of a so-called “light-up” test. If necessary in the event of inadequate adhesion of one or more sealing hoods and/or a failure of one or more light sources the panel can be reworked. The panel is then lacquered with the protective lacquer and the protective lacquer is subsequently UV-cured. In a following sub-step, the panel is separated, in particular cut, into the individual carriers or light bands. The carriers or light bands are then wound up.

In a step S10, an alternative to steps S8 and S9, the panel or advantageously the separated light bands can be encapsulated with silicone.

FIG. 10 shows a side view in a sectional representation of a light band 40 having two sealing hoods 41a, 41b (double arrangement) situated mirror symmetrically opposite one another at a dividing point T according to a fourth embodiment. FIG. 11 shows a view along a sectional plane A-A from FIG. 10 by way of example of the sealing hood 41a which is constructed identically to the sealing hood 41b.

With reference to FIG. 10 and FIG. 11, each of the sealing hoods 41a, 41b has a housing 42 open at the bottom which now however in contrast to the embodiments described previously is not hollow but is filled. To this end, by way of example here four individual metallic sockets 43 are molded into the housing 42 by means of an encapsulation compound 44. The sockets 43 each have a pin receptacle 45 open on the front side in the form of a countersink for receiving a respective contact pin (not shown here). In order that the contact pins are gripped securely they can for example be configured with spring elements (sprung abutments or similar) or as a spring, have one or more clamping hooks and/or have a conical basic shape having a width extending somewhat beyond a width of the pin receptacle 45.

The underside of the sockets 43 is exposed in order to allow contact to be made with a respective electrical contact 7 when the sealing hood 41a is fitted onto the carrier 4. The sockets 43 are thus distributed across the width, corresponding to the electrical contacts 7. The width of the sockets 43 advantageously corresponds essentially to at least a width of the electrical contacts 7, as shown in FIG. 11, in order to achieve a large contact area between the sockets 43 and the respective electrical contact 7. The sockets 43 may consist of any suitable material, for example Cu, Ag or VA coated for example with Au or Ag.

In order to fasten the sealing hoods 41a, 41b on the carrier 4 they can be adhesively bonded onto the carrier 4 by means of the housing 42. For example, in order to ensure a sufficiently large contact area for adhesion and/or to achieve improved support for the sealing hood 41a or 42a in the case of an encapsulation, the housing 42 has at its lower edge a peripheral flange 46.

Alternatively or in addition, the sockets 43 can be designed as solderable and therefore be soldered to the electrical contact 7 after the sealing hoods 41a, 41b have been fitted. A sealing hood 41a, 41b can then also be regarded as a type of solderable luster terminal. The type of soldering can differ and can for example comprise a simple soldering operation or an SMD soldering process. To this end, for example solder volumes 47 (solder balls or similar) can be present on the underside of the sockets 43.

As distinguished from the embodiments from FIG. 6 or FIG. 7 for example, here the first, opaque encapsulation compound 28 reaches only as far as a top edge of the sealing hoods 41a, 41b. The second, transparent encapsulation compound 32 has been applied in one operation onto the first encapsulation compound 28 and the sealing hoods 41a, 41b. For uniformity of color, it is preferred that the first encapsulation compound 28 and the sealing hoods 41b have essentially the same color, for example white.

A dividing point T is provided between the two sealing hoods 41a, 41b for separating the light band 40. In order to ensure that the front side or end face of the sealing hoods 41a, 41b, in particular the pin receptacles 45 open on the front side, are sealed, the end face of the sealing hoods 41a, 41b is sealed by means of a sealing wall 48. The sealing wall 48 can for example be designed as an elastomer skin (in particular a silicone skin), for example as part of a cap. In order to insert the contact pins into the pin receptacles 45 the sealing wall 48 there can either be removed, for example cut off or scratched away, or the contact pins simply push through the comparatively thin sealing wall 48.

With regard to the double arrangement shown, the housing 42 can be designed both as dividable and also as non-dividable. The housing 42 can for example consist of a soft elastic plastic, for example an elastomer (rubber, silicone etc.), or a hard plastic. For simple and cost-effective manufacturing, the housing 42 can be an injection molded part.

The present invention is naturally not restricted to the exemplary embodiments described.

In principle, assembly of the sealing hoods can take place on a panel or on single-strip carriers or light bands.

In general, the adhesive bonding of the sealing hood(s) can be performed in self-adhesive fashion (for example by means of a double-sided adhesive tape) or by means of an active quantity of adhesive.

As an alternative to adhesively bonding the sealing hoods, the sealing hoods can also be soldered, in particular with regard to assembly on a (multi-strip) panel. The soldering can take place for example through the use of solder inserts (for example copper inserts) or solder pads made of copper or similar which are present on the sealing hood or the sealing hoods. Corresponding solder inserts or solder pads are then present on the carrier or the carriers.

Both in the case of the divided sealing hood which has a plug connector inserted and also in the case of the undivided sealing hood, the receiving space can subsequently be infilled with a sealing agent (for example silicone gel) in order to yet further increase the sealing protection. The sealing agent can therefore be injected through the soft elastic sealing hood into the receiving space.

The number of sockets per sealing hood is not restricted and can comprise one or more sockets. The number of sockets can typically be chosen in circuit dependent fashion.

### LIST OF REFERENCE CHARACTERS

1 Light band
1a Divided light band
1b Divided light band
2 Sealing hood
2a Divided sealing hood
2b Divided sealing hood
3 Lighting module
4 Carrier
5 Module carrier
6 Light emitting diode
7 Electrical contact
8 End face
9 Receiving space
10 Sealing hood
10a Divided sealing hood
10b Divided sealing hood
11 Housing
12 Indentation
13 Sealing lip
13a Sealing lip
14 Inner surface
15 Lower free edges
16 Sealing hood
17 Side surface of the carrier
18 Housing
19 Light band
20 Separated sealing hood
21 Plug
22 Underside
23 Receiving space
24 Sealing lip
25 Clamp wire
26 Upper side
27 Profile rail
28 First encapsulation compound
29 Projection
31 Emission surface
32 Second encapsulation compound
33 Light band
34 Sealing hood
35 Separated sealing hood
36 Receiving space
37 Plug
38 Shell side
38a Housing
39 Lead-through
40 Light band
41a Sealing hood
41b Sealing hood
42 Housing
43 Socket
44 Encapsulation compound
45 Pin receptacle
46 Peripheral flange
47 Solder volume
48 Sealing wall
49 Notch
T Dividing point
T1 Dividing point
T2 Dividing point

1. A light band, comprising:
a band-shaped carrier for at least one light source, in particular a light emitting diode, wherein the carrier includes electrical contacts; and
at least one sealing hood fastened to the carrier, which at least partially overarches at least one of the electrical contacts.

2. The light band as claimed in claim 1, wherein the sealing hood has at least one internal sealing element.

3. The light band as claimed in claim 1, wherein the sealing hood has a housing having an open underside, wherein the underside is closed by the carrier.

4. The light band as claimed in claim 1, wherein the sealing hood forms a housing closed at least on the shell side, which has at least one lead-through for at least one of the electrical contacts.

5. The light band as claimed in claim 1, wherein the at least one sealing hood has at least one electrically conductive socket for receiving a contact pin and the at least one socket is electrically connected in each case to one of the electrical contacts.

6. The light band as claimed in claim 5, wherein the at least one socket is molded in a housing.

7. The light band as claimed in claim 1, wherein the at least one socket is soldered to the respective electrical contact.

8. The light band as claimed in claim 1, wherein the at least one sealing hood is arranged on one end face of the light band and is open towards the end face.

9. The light band as claimed in claim 1, wherein the at least one sealing hood is arranged in sealing fashion on an internal section of the carrier and overarches a dividing point of the light band.

10. The light band as claimed in claim 9, comprising a plurality of integrally contiguous, essentially identical unit carrier sections, which can be divided at the dividing point.

11. The light band as claimed in claim 1, wherein the sealing hood has housing walls comprising a comparatively hard material and a dividing point comprising a comparatively soft material.

12. The light band as claimed in claim 1, wherein the carrier is at least partially encapsulated.

13. A method for producing a light band as claimed in claim 8, wherein the at least one sealing hood is fitted onto the carrier and, subsequently, the light band is at least partially encapsulated.

14. The method as claimed in claim 13, wherein a housing of the sealing hood is adhesively bonded to the carrier prior to encapsulation.

15. (canceled)

16. The light band as claimed in claim 2, wherein said sealing element is a sealing lip.
